(19) United States
(12) Patent Application Publication
(10) Pub. No.: US 2021/0031366 A1
(43) Pub. Date: Feb. 4, 2021

(54) DETECTION METHOD AND ROBOT

(71) Applicant: Seiko Epson Corporation, Tokyo (JP)

(72) Inventor: Mitsuhiro YAMAMURA, Suwa (JP)

(21) Appl. No.: 16/941,756

(22) Filed: Jul. 29, 2020

(30) Foreign Application Priority Data
Jul. 30, 2019 (JP) 2019-139492

(51) Int. Cl. B25J 9/16; B25J 9/04; B25J 13/08; G05B 19/401

(52) U.S. Cl. CPC B25J 9/1664; B25J 9/042; G05B 2219/37284; G05B 19/401; B25J 13/086

(57) ABSTRACT

A detection method by a robot having a robot arm and a capacitance proximity sensor placed on the robot arm of detecting an object located around the robot, includes applying a drive voltage to a drive electrode of the proximity sensor, generating a corrected detection signal by correcting a detection signal output from a detection electrode of the proximity sensor based on a posture of the robot arm, and detecting the object located around the robot based on the corrected detection signal.

The present application is based on, and claims priority from JP Application Serial Number 2019-139492, filed Jul. 30, 2019, the disclosure of which is hereby incorporated by reference herein in its entirety.

### BACKGROUND

### 1. Technical Field

The present disclosure relates to a detection method and a robot.

### 2. Related Art

A robot disclosed in JP-A-2018-149673 has a first arm, a second arm pivotably coupled to the first arm, and a third arm pivotably coupled to the second arm, and proximity sensors are respectively provided in the first arm and the second arm.

However, in the robot having the above described configuration, the proximity sensor provided in the first arm and the proximity sensor provided in the second arm may be too close and interfere with each other depending on the posture of the second arm relative to the first arm. As a result, false detection by the proximity sensors may occur.

### SUMMARY

A detection method according to an aspect of the present disclosure is a detection method by a robot having a robot arm and a capacitance proximity sensor placed on the robot arm of detecting an object located around the robot, including applying a drive voltage to a drive electrode of the proximity sensor, generating a corrected detection signal by correcting a detection signal output from a detection electrode of the proximity sensor based on a posture of the robot arm, and detecting the object located around the robot based on the corrected detection signal.

### BRIEF DESCRIPTION OF THE DRAWINGS

FIG. 1 is a general view showing a robot according to a first embodiment of the present disclosure.

FIG. 2 is a side view showing a placement of proximity sensors.

FIG. 3 shows the proximity sensor.

FIG. 4 is a plan view showing a detection electrode and a drive electrode of the proximity sensor.

FIG. 5 is a block diagram of a proximity sensor control unit.

FIG. 6 shows a drive voltage.

FIG. 7 is a model diagram showing electric lines of force generated around the proximity sensor.

FIG. 8 is a model diagram showing electric lines of force generated around the proximity sensor.

FIG. 9 is a model diagram showing electric lines of force generated around the proximity sensor.

FIG. 10 shows an example of correction voltage information stored in the proximity sensor control unit.

FIG. 11 shows modified examples of correction voltages.

FIG. 12 is a block diagram of a proximity sensor control unit according to a second embodiment of the present disclosure.

FIG. 13 shows an example of capacitance information stored in the proximity sensor control unit.

FIG. 14 is a model diagram showing electric lines of force generated around a proximity sensor.

FIG. 15 is a model diagram showing electric lines of force generated around the proximity sensor.

FIG. 16 is a model diagram showing electric lines of force generated around the proximity sensor.

### DESCRIPTION OF EXEMPLARY EMBODIMENTS

As below, a detection method and a robot of the present disclosure will be explained in detail based on preferred embodiments shown in the accompanying drawings.

### First Embodiment

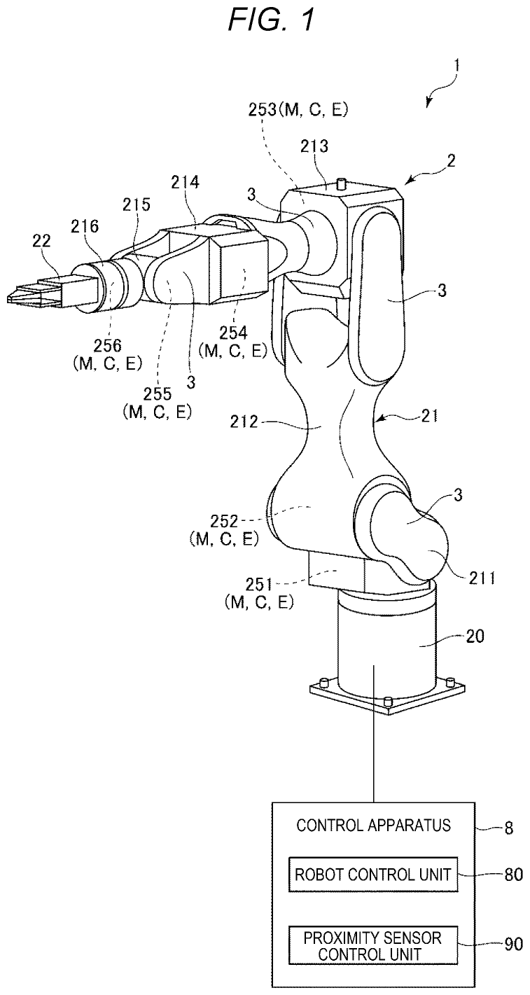

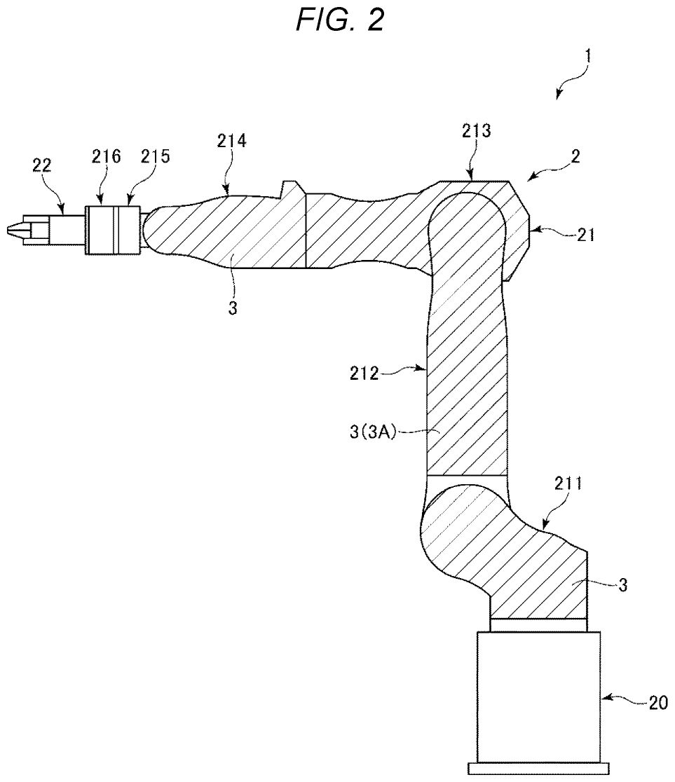

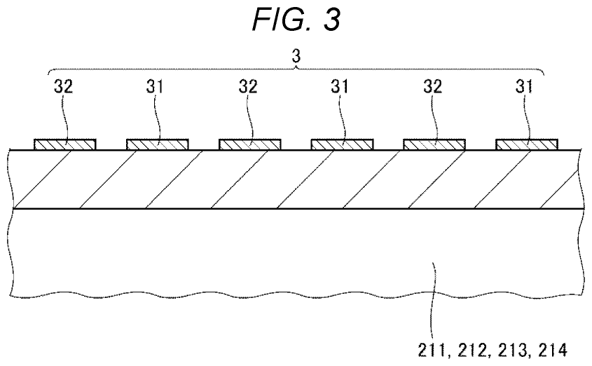

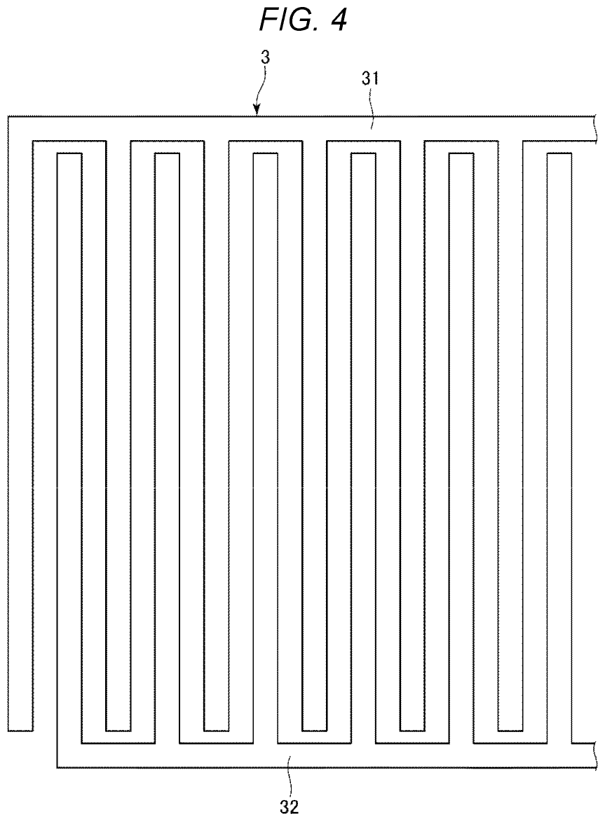

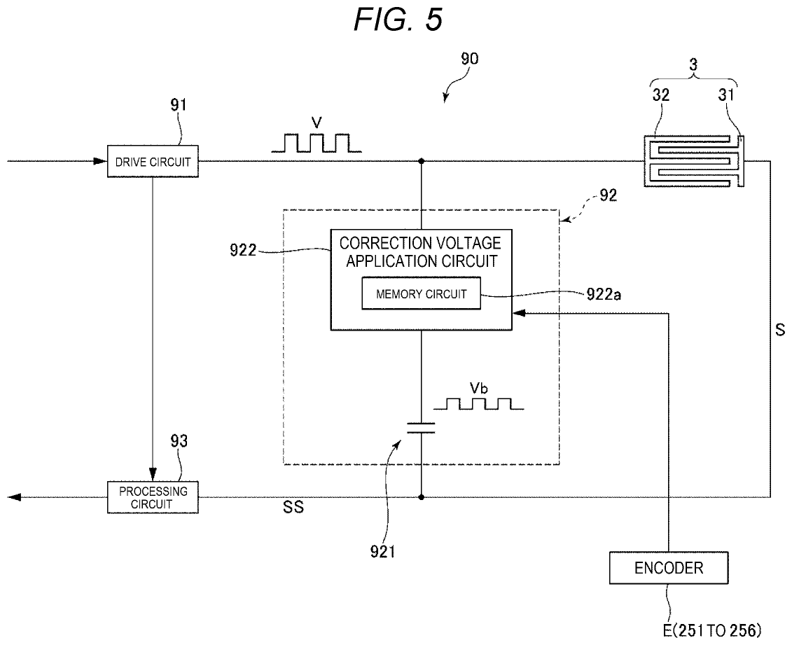

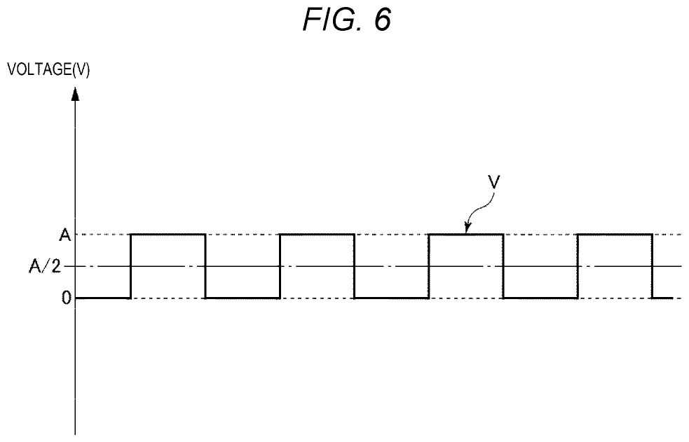

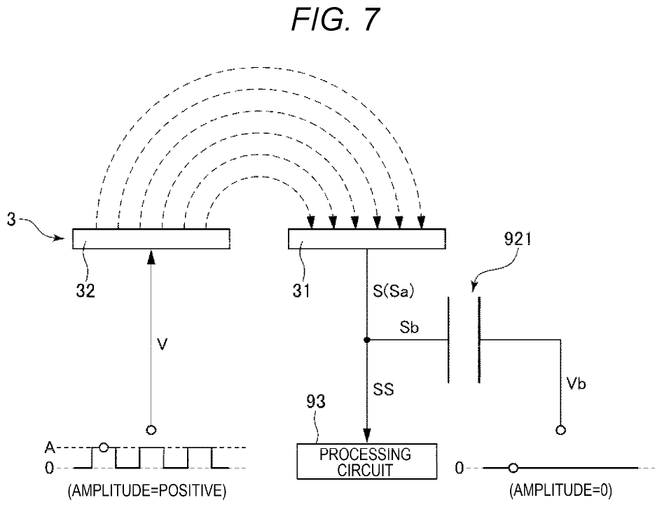

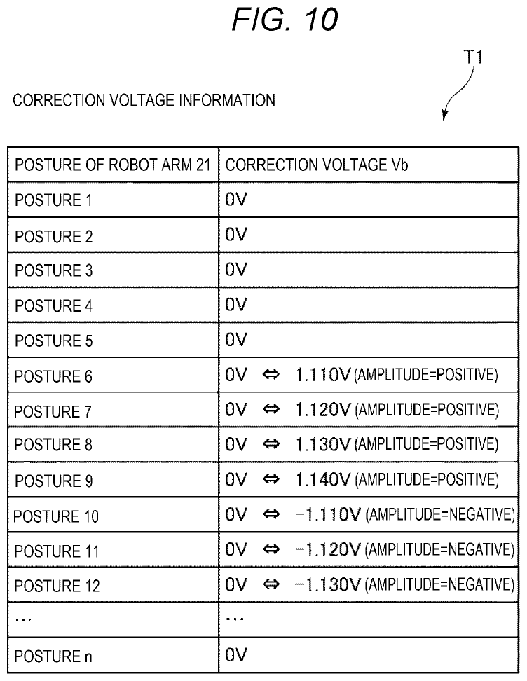

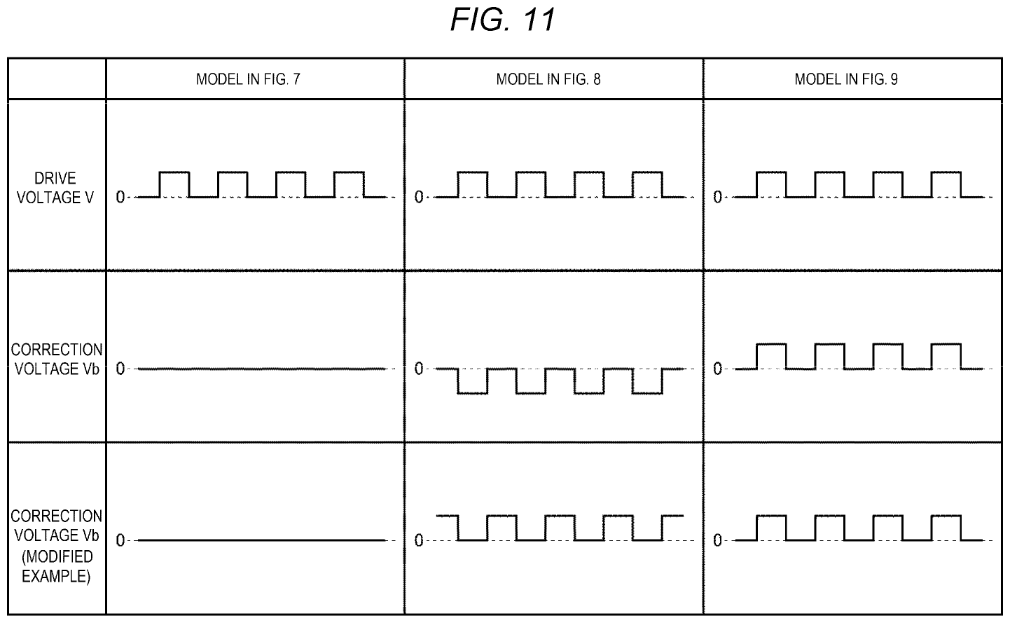

FIG. 1 is the general view showing the robot according to the first embodiment of the present disclosure. FIG. 2 is the side view showing a placement of proximity sensors. FIG. 3 shows the proximity sensor. FIG. 4 is the plan view showing the detection electrode and the drive electrode of the proximity sensor. FIG. 5 is the block diagram of the proximity sensor control unit. FIG. 6 shows the drive voltage. FIGS. 7 to 9 are respectively the model diagrams showing electric lines of force generated around the proximity sensor. FIG. 10 shows the example of correction voltage information stored in the proximity sensor control unit. FIG. 11 shows the modified examples of correction voltages.

A robot 1 shown in FIG. 1 may perform work of feeding, removing, transport, assembly, etc. of precision apparatuses and components forming the apparatuses. The robot 1 has a robot main body 2 that executes predetermined work, proximity sensors 3 attached to the robot main body 2 and detecting an object, particularly, a human located around the robot, and a control apparatus 8 controlling driving of the robot main body 2 and the proximity sensors 3.

The robot main body 2 is a six-axis robot. The robot main body 2 has a base 20 fixed to a floor, a wall, a ceiling, or the like, a robot arm 21, and an end effector 22 attached to the distal end of the robot arm 21. Further, the robot arm 21 has an arm 211 pivotably coupled to the base 20, an arm 212 pivotably coupled to the arm 211, an arm 213 pivotably coupled to the arm 212, an arm 214 pivotably coupled to the arm 213, an arm 215 pivotably coupled to the arm 214, and an arm 216 pivotably coupled to the arm 215, and the end effector 22 is attached to the arm 216.

The robot main body 2 has a drive device 251 that pivots the arm 211 relative to the base 20, a drive device 252 that pivots the arm 212 relative to the arm 211, a drive device 253 that pivots the arm 213 relative to the arm 212, a drive device 254 that pivots the arm 214 relative to the arm 213, a drive device 255 that pivots the arm 215 relative to the arm 214, and a drive device 256 that pivots the arm 216 relative to the arm 215. The respective drive devices 251 to 256 have e.g. motors M as drive sources, controllers C that control driving of the motors M, and encoders E that detect amounts of rotation of the motors M, i.e., rotation angles of the arms. These drive devices 251 to 256 are respectively independently controlled by the control apparatus 8.

Note that the configuration of the robot main body 2 is not particularly limited, but the number of arms may be e.g. five or less or seven or more. Further, for example, the robot main body 2 may be a scalar robot, a dual-arm robot, or the like.

The control apparatus 8 has a robot control unit 80 that receives a position command of the robot main body 2 from a host computer (not shown) and respectively independently controls driving of the drive devices 251 to 256 so that the respective arms 211 to 216 may be located in positions according to the received position command, and a proximity sensor control unit 90 that controls driving of the proximity sensors 3 and detects an object located around the robot main body 2 based on detection signals S output by the proximity sensors 3. For example, when the proximity sensor control unit 90 detects an object located around the robot main body 2, the robot control unit 80 urgently stops driving of the robot main body 2 or reduces the driving speed of the robot arm 21 regardless of the command from the host computer. Thereby, the robot 1 may be safely driven.

The control apparatus 8 includes e.g. a computer having a processor (CPU) that processes information, a memory communicably coupled to the processor, and an external interface. Further, various programs executable by the processor are stored in the memory and the processor may read and execute various programs stored in the memory etc.

The proximity sensors 3 are placed on outer surfaces of the robot arm 21. Particularly, in the embodiment, the proximity sensors 3 are placed in parts shown by hatching in FIG. 2, i.e., on the arms 211, 212, 213, 214. The proximity sensors 3 are placed on the plurality of arms, and thereby, an object located around the robot arm 21 may be detected over a wider range. Note that the placement of the proximity sensor 3 is not particularly limited, but may be on the arm 214 only, for example.

Each proximity sensor 3 is a capacitance sensor of mutual capacitance system for detecting an object located around the sensor based on a change of capacitance and, as shown in FIG. 3, has a detection electrode 31 and a drive electrode 32. Further, as shown in FIG. 4, the detection electrode 31 and the drive electrode 32 are provided apart from each other. The detection electrode 31 and the drive electrode 32 respectively have comb-teeth shapes in a plan view and are placed with the comb teeth of the detection electrode 31 and the comb teeth of the drive electrode 32 separated from each other side by side with each other. When a drive voltage V is applied to the drive electrode 32, an electric field is generated between the detection electrode 31 and the drive electrode 32. When an object to be detected approaches the proximity sensor 3 with the electric field generated, the electric field between the detection electrode 31 and the drive electrode 32 changes. A change of capacitance due to the change of the electric field is detected by the detection electrode 31, and thereby, the approach of the object to the robot main body 2 may be detected.

Control methods of the four proximity sensors 3 placed on the arms 211, 212, 213, 214 are the same and, for convenience of explanation, the control method of the proximity sensor 3 placed on the arm 214 will be representatively explained and the explanation of the control methods of the other proximity sensors 3 will be omitted.

As shown in FIG. 5, the proximity sensor control unit 90 has a drive circuit 91 that generates the drive voltage V periodically changing based on a predetermined clock, and the drive voltage V generated in the drive circuit 91 is applied to the drive electrode 32. Further, the proximity sensor control unit 90 has a correction circuit 92 that corrects a detection signal S (amount of electric charge) output from the detection electrode 31 according to the posture of the robot arm 21, and a processing circuit 93 that measures a corrected detection signal SS corrected by the correction circuit 92 in synchronization with the drive voltage V and detects the object located around the proximity sensor 3 based on the measurement result.

The correction circuit 92 has a capacitor 921 as a correction capacitance formation unit for forming correction capacitance electrically coupled to the detection electrode 31 and a correction voltage application circuit 922 that applies a correction voltage Vb in synchronization with the drive voltage V to the capacitor 921. Note that the correction voltage Vb is a voltage periodically changing based on a predetermined clock and has the same frequency as the drive voltage V. The above described “same frequency” includes not only the case where the frequencies coincide with each other but also cases where the frequencies have slight differences that may be technically generated. The capacitor 921 has a property that capacitance changes according to the amplitude of the correction voltage Vb.

The correction voltage application circuit 922 may acquire output information of the encoders E of the respective drive devices 251 to 256 and detect the posture of the robot arm 21 from the acquired output information. Thereby, the posture of the robot arm 21 may be accurately detected. Note that the configuration of the correction voltage application circuit 922 is not limited to that, but may be e.g. a configuration in which the correction voltage application circuit 922 acquires information on the posture of the robot arm 21 detected by another circuit based on the output from the respective encoders E.

Further, the correction voltage application circuit 922 is electrically coupled to the drive circuit 91 and the drive voltage V is input thereto. Thereby, the correction voltage application circuit 922 may easily synchronize the correction voltage Vb and the drive voltage V. The drive voltage V and the correction voltage Vb are synchronized, and thereby, rising and falling times of the drive voltage V and the correction voltage Vb may be synchronized. Accordingly, the detection signal S may be accurately corrected using the correction circuit 92 and the accurate corrected detection signal SS may be obtained.

As above, the circuit configuration of the proximity sensor control unit 90 is explained. Next, the control method of the proximity sensor 3 by the proximity sensor control unit 90, i.e., the detection method of the object by the proximity sensor 3 will be explained.

First, the drive voltage V is generated in the drive circuit 91 and the generated drive voltage V is applied to the drive electrode 32. As shown in FIG. 6, the drive voltage V has rectangular wave with positive amplitude, i.e., a voltage value (V) periodically changing between 0 and A (A>0). Note that the drive voltage V is not particularly limited. On the other hand, the detection electrode 31 is maintained at a constant voltage of A/2 shown by a dot-dash line. Thereby, the detection signal S (amount of electric charge) based on the magnitude of the capacitance formed between the drive electrode 32 and detection electrode 31 is output from the detection electrode 31. When an object to be detected approaches the proximity sensor 3 in this state, the detection signal S output from the detection electrode 31 changes due to interference between the approaching object and the proximity sensor 3. Accordingly, the processing circuit 93 may detect the approach of the object to the robot main body 2 based on the change of the detection signal S.

However, the detection signal S output from the proximity sensor 3 fluctuates also due to interference between another object than the object to be detected and the proximity sensor 3. Examples are shown in FIGS. 7 to 9. Note that the models shown in FIGS. 7 to 9 are different from one another in posture of the robot arm 21 and show electric lines of force acting at times indicated by “circles” in the waveforms of the drive voltage V shown in the respective drawings.

In the model shown in FIG. 7, the proximity sensor 3 does not interfere with another object. Note that, for convenience of explanation, it is assumed that six electric lines of force act on the detection electrode 31 and the detection signal S output from the detection electrode 31 in this state is also referred to as “reference detection signal Sa”.

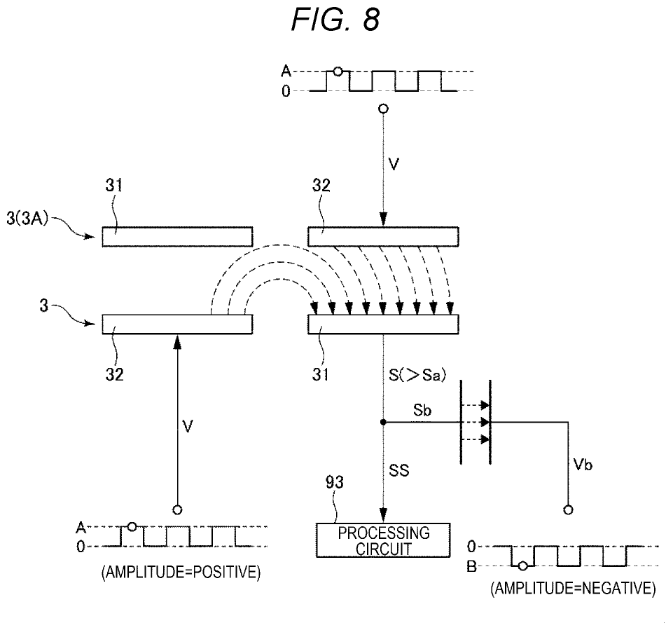

On the other hand, for example, in the model shown in FIG. 8, the proximity sensor 3 approaches to the proximity sensor 3 (3A) of the other arm and these interfere with each other. Thereby, the electric lines of force from the drive electrode 32 of the proximity sensor 3A act on the detection electrode 31 and the nine electric lines of force more than those in the model in FIG. 7 act on the detection electrode 31. Accordingly, the detection signal S output from the detection electrode 31 is larger than the reference detection signal Sa.

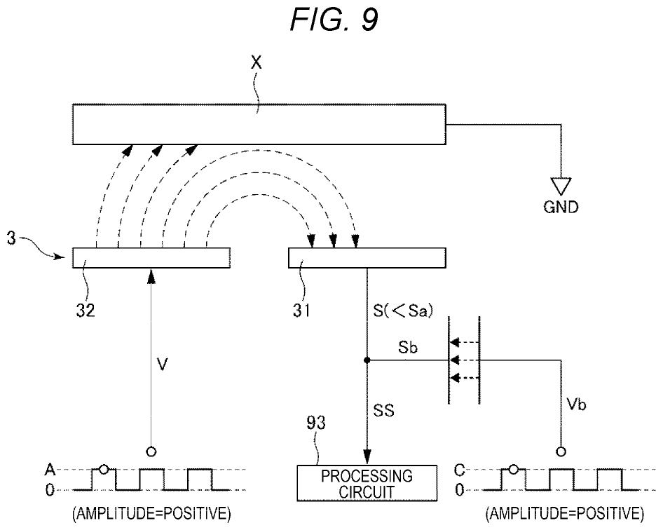

On the contrary, for example, in the model shown in FIG. 9, the proximity sensor 3 approaches a structure X as a conductor such as mechanical equipment, a safety fence, a peripheral device exterior, or a cable located around the robot main body 2 and these interfere with each other. Thereby, part of the electric lines of force are shielded by the structure X and the three electric lines of force less than those in the model in FIG. 7 act on the detection electrode 31. Accordingly, the detection signal S output from the detection electrode 31 is smaller than the reference detection signal Sa.

As described above, when the detection signal S fluctuates due to the posture of the robot arm 21, i.e., another factor than the approach of the object to be detected, the processing circuit 93 falsely senses the approach of the object and the detection accuracy of the object is lower. Accordingly, the proximity sensor control unit 90 includes the correction circuit 92 that corrects the detection signal S due to the posture of the robot arm 21 to reduce the unintended fluctuations preferably to zero.

As described above, the correction circuit 92 has the capacitor 921 electrically coupled to the detection electrode 31 and the correction voltage application circuit 922 that applies the correction voltage Vb to the capacitor 921.

Further, as shown in FIG. 5, the correction voltage application circuit 922 has a memory circuit 922a and correction voltage information T1 shown in FIG. 10 is stored in the memory circuit 922a. The correction voltage information T1 is information of the correction voltage Vb applied to the capacitor 921 for reduction of the fluctuations of the detection signal S due to the posture of the robot arm 21 preferably to zero, and stored as table data in which a plurality of postures of the robot arm 21 and the correction voltages Vb applied to the capacitor 921 in the respective postures are connected. The method of acquiring the correction voltage information T1 is not particularly limited to, but includes e.g. a method of teaching the robot 1 in advance.

For example, prior to use, the robot 1 first detects the reference detection signal Sa output from the detection electrode 31 when the robot arm 21 is in the reference posture, i.e., in the posture without interference with another object like the model in FIG. 7 and the detection signal S output from the detection electrode 31 when the robot arm 21 in various postures different from the reference posture, i.e., in the posture with interference with the robot arm 21 itself like the model shown in FIG. 8 or the posture with interference with the structure X like the model shown in FIG. 9. Then, the robot 1 compares the reference detection signal Sa and the detection signal S with respect to each posture, obtains the correction voltage Vb to reduce a difference ΔS between the reference detection signal Sa and the detection signal S preferably to zero, and stores the obtained correction voltage Vb as the correction voltage information T1.

The explanation is made using the above described model diagrams in FIGS. 7 to 9. In the model shown in FIG. 7, the proximity sensor 3 does not interfere with another object and the six electric lines of force act on the detection electrode 31. At the same time, the correction voltage Vb of 0 V is applied to the capacitor 921 from the correction voltage application circuit 922 and zero electric lines of force are formed in the capacitor 921. That is, in this model, the correction circuit 92 generates the corrected detection signal SS corresponding to the six electric lines of force by adding a correction signal Sb corresponding to the zero electric lines of force to the detection signal S (reference detection signal Sa) having the magnitude corresponding to the six electric lines of force. In other words, the correction circuit 92 uses the detection signal S as the corrected detection signal SS without correction.

On the other hand, in the model shown in FIG. 8, the proximity sensor 3 interferes with the other proximity sensor 3A and the nine electric lines of force more than those in the model in FIG. 7 act on the detection electrode 31. At the same time, the rectangular correction voltage Vb with negative amplitude in the opposite direction to that of the drive voltage V having a voltage value (V) periodically changing between 0 and B (B<0) is applied to the capacitor 921 from the correction voltage application circuit 922, and three electric lines of force in the opposite direction to the electric lines of force acting on the detection electrode 31 are formed. That is, in this model, the correction circuit 92 generates the corrected detection signal SS corresponding to the six electric lines of force by adding the correction signal Sb corresponding to the minus three electric lines of force to the detection signal S having the magnitude corresponding to the nine electric lines of force. Note that the value of B (<0) is varied according to the relative position relationship with the proximity sensor 3A, i.e., the number of electric lines of force acting on the detection electrode 31.

On the contrary, in the model shown in FIG. 9, the proximity sensor 3 interferes with the structure X and the three electric lines of force less than those of the model in FIG. 7 act on the detection electrode 31. At the same time, the rectangular correction voltage Vb with positive amplitude in the same direction with that of the drive voltage V having a voltage value (V) periodically changing between 0 and C (C>0) is applied to the capacitor 921 from the correction voltage application circuit 922, and three electric lines of force in the same direction with the electric lines of force acting on the detection electrode 31 are formed. That is, in this model, the correction circuit 92 generates the corrected detection signal SS corresponding to the six electric lines of force by adding the correction signal Sb corresponding to the three electric lines of force to the detection signal S having the magnitude corresponding to the three electric lines of force. Note that the value of C (>0) is varied according to the relative position relationship with the structure X, i.e., the number of electric lines of force acting on the detection electrode 31.

As described above, the correction circuit 92 controls the correction voltage Vb applied to the capacitor 921 so that the corrected detection signal SS having the magnitude corresponding to the six electric lines of force may be constantly generated with or without interference. Thereby, the corrected detection signal SS in which fluctuations of the detection signal S due to the posture of the robot arm 21 are cancelled is constantly generated by the correction circuit 92.

As described above, the processing circuit 93 detects the approach of the object to be detected based on the corrected detection signal SS generated by the correction circuit 92. According to the configuration, the fluctuations of the detection signal S caused by another factor than the posture of the robot arm 21, i.e., the approach of the object to be detected are suppressed, and thereby, the processing circuit 93 may accurately detect the approach of the object.

As above, the robot 1 is explained. As described above, the robot 1 includes the robot arm 21, the capacitance proximity sensor 3 having the detection electrode 31 and the drive electrode 32 placed on the robot arm 21 and detecting the object located around the robot, the drive circuit 91 applying the drive voltage V to the drive electrode 32, the correction circuit 92 generating the corrected detection signal SS by correcting the detection signal S output from the detection electrode 31 based on the posture of the robot arm 21, and the processing circuit 93 detecting the object located around the robot 1 based on the corrected detection signal SS. According to the robot 1 having the configuration, the corrected detection signal SS in which fluctuations of the detection signal S due to the posture of the robot arm 21 are cancelled may be obtained, and thereby, the object located around the robot 1 may be detected more accurately.

As described above, the correction circuit 92 has the capacitor 921 as the correction capacitance formation unit electrically coupled to the detection electrode 31, and the correction voltage application circuit 922 applying the correction voltage Vb to the capacitor 921. Thereby, the configuration of the correction circuit 92 is simpler.

As described above, the detection method by the robot 1 having the robot arm 21 and the capacitance proximity sensor 3 placed on the robot arm 21 of detecting the object located around the robot includes applying the drive voltage V to the drive electrode 32 of the proximity sensor 3, generating the corrected detection signal SS by correcting the detection signal S output from the detection electrode 31 of the proximity sensor 3 based on the posture of the robot arm 21, and detecting the object located around the robot 1 based on the corrected detection signal SS. According to the detection method having the configuration, the corrected detection signal SS in which fluctuations of the detection signal S due to the posture of the robot arm 21 are cancelled may be obtained, and thereby, the object located around the robot 1 may be detected more accurately.

As described above, in the detection method, the correction voltage Vb is applied to the capacitor 921 as the correction capacitance formation unit electrically coupled to the detection electrode 31, the detection signal S is corrected, and the corrected detection signal SS is generated. Thereby, the corrected detection signal SS may be generated by the simple method.

As described above, in the detection method, the correction voltage information T1 based on the posture of the robot arm 21 and the correction voltage Vb is acquired and the correction voltage Vb is controlled based on the correction voltage information T1 and the posture of the robot arm 21. Thereby, the correction voltage Vb may be controlled by the simple method.

As described above, in the detection method, the detection of the posture of the robot arm 21 is based on the output of the encoder E of the robot arm 21. Thereby, the posture of the robot arm 21 may be accurately detected by the simple configuration.

As described above, the drive voltage V and the correction voltage Vb are synchronized. Thereby, the rising and falling times of the drive voltage V and the correction voltage Vb may be synchronized. Accordingly, the detection signal S may be accurately corrected using the correction circuit 92 and the accurate corrected detection signal SS may be obtained.

As above, the robot 1 is explained, however, the configuration thereof is not limited to the above described configuration. For example, as shown in FIG. 11, in the embodiment, the correction voltage Vb applied to the capacitor 921 at the time of the posture shown in FIG. 8 is the rectangular voltage with negative amplitude in the opposite direction to that of the drive voltage V having the voltage value (V) periodically changing between 0 and B (B<0), however, a rectangular voltage in the opposite phase to that of the drive voltage V may be used instead. Further, in the embodiment, the potential of the detection electrode 31 is fixed to A/2 and the amount of electric charge output from the detection electrode 31 is used as the detection signal S, however, for example, the potential of the detection electrode 31 is not fixed, but the change of the potential of the detection electrode 31 may be used as the detection signal S. The configurations may also exert the same effects as those of the embodiment.

### Second Embodiment

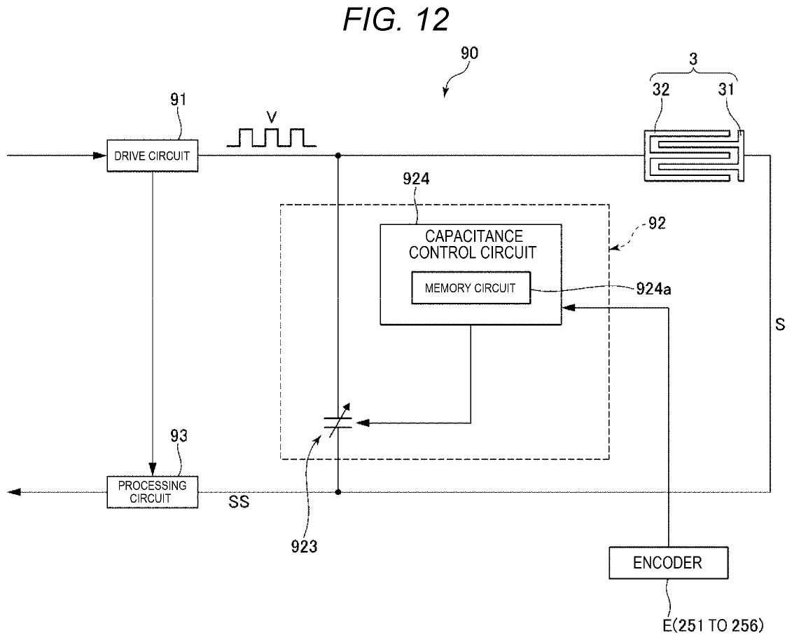

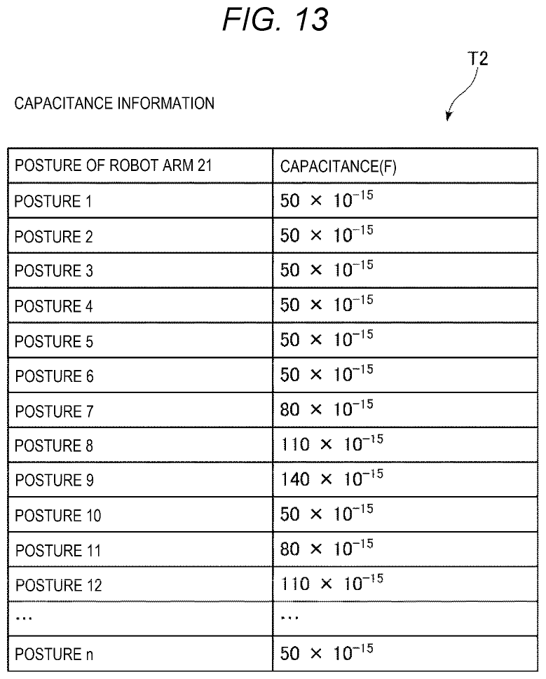

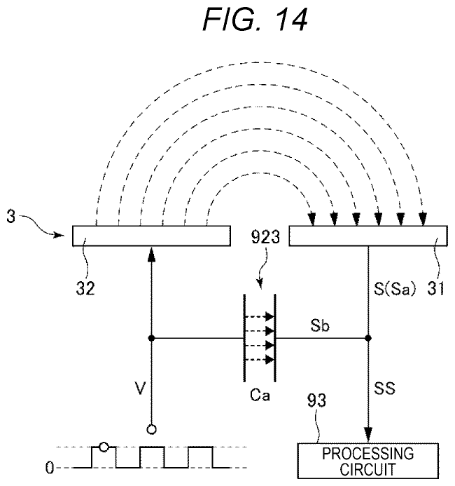

FIG. 12 is the block diagram of the proximity sensor control unit according to the second embodiment of the present disclosure. FIG. 13 shows the example of capacitance information stored in the proximity sensor control unit. FIGS. 14 to 16 are respectively model diagrams showing electric lines of force generated around the proximity sensor.

The embodiment is the same as the above described first embodiment except that the configuration of the correction circuit 92 is different. Accordingly, in the following description, the embodiment will be explained with a focus on differences from the above described embodiment and the explanation of the same items will be omitted. Further, in FIGS. 12 to 16, the same configurations as those of the above described embodiment have the same signs.

As shown in FIG. 12, the correction circuit 92 of the embodiment has a variable capacitor 923 as a variable correction capacitance formation unit coupled in parallel to the proximity sensor 3 between the drive circuit 91 and the processing circuit 93, and a capacitance control circuit 924 controlling the capacitance of the variable capacitor 923. In the correction circuit 92, the drive voltage V is applied to the variable capacitor 923, the magnitude of the capacitance of the variable capacitor 923 is changed by the capacitance control circuit 924, and thereby, the detection signal S is corrected and the corrected detection signal SS is generated. According to the configuration, the configuration of the correction circuit 92 is simpler. Particularly, the drive voltage V is applied to the variable capacitor 923, and thereby, the configuration of the correction circuit 92 is even simpler. Specifically, for example, it is not necessary to form such a complex configuration that another voltage than the drive voltage V is applied in synchronization with the drive voltage V, and the configuration of the correction circuit 92 is simpler thereby.

The capacitance control circuit 924 has a memory circuit 924a and capacitance information T2 of the variable capacitor 923 as shown in FIG. 13 is stored in the memory circuit 924a. The capacitance information T2 is information of the capacitance of the variable capacitor 923 to be changed to reduce the fluctuations of the detection signal S due to the posture of the robot arm 21 preferably to zero, and stored as table data in which a plurality of postures of the robot arm 21 and the capacitance of the variable capacitor 923 in the respective postures are connected. The method of acquiring the capacitance information T2 is not particularly limited to, but includes e.g. a method of teaching the robot 1 in advance.

The explanation is made using the models shown in FIGS. 14 to 16. In the model shown in FIG. 14, the proximity sensor 3 does not interfere with another object and the six electric lines of force act on the detection electrode 31. At the same time, the capacitance of the variable capacitor 923 is set to capacitance Ca by the capacitance control circuit 924, and four electric lines of force in the same direction as that of the electric lines of force acting on the detection electrode 31 are formed in the variable capacitor 923. That is, in this model, the correction circuit 92 generates the corrected detection signal SS corresponding to the ten electric lines of force by adding the correction signal Sb corresponding to the four electric lines of force to the detection signal S (reference detection signal Sa) having the magnitude corresponding to the six electric lines of force.

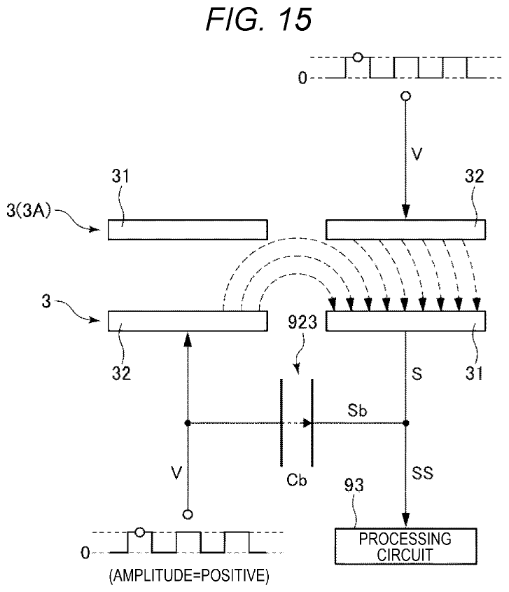

On the other hand, in the model shown in FIG. 15, the proximity sensor 3 interferes with the other proximity sensor 3A and the nine electric lines of force more than those in the model in FIG. 14 act on the detection electrode 31. At the same time, the capacitance of the variable capacitor 923 is set to capacitance Cb smaller than the capacitance Ca by the capacitance control circuit 924, and one electric line of force in the same direction as that of the electric lines of force acting on the detection electrode 31 is formed in the variable capacitor 923. That is, in this model, the correction circuit 92 generates the corrected detection signal SS corresponding to the ten electric lines of force by adding the correction signal Sb corresponding to the one electric line of force to the detection signal S having the magnitude corresponding to the nine electric lines of force. Note that the value of Cb (<Ca) is varied according to the relative position relationship with the proximity sensor 3A, i.e., the number of electric lines of force acting on the detection electrode 31.

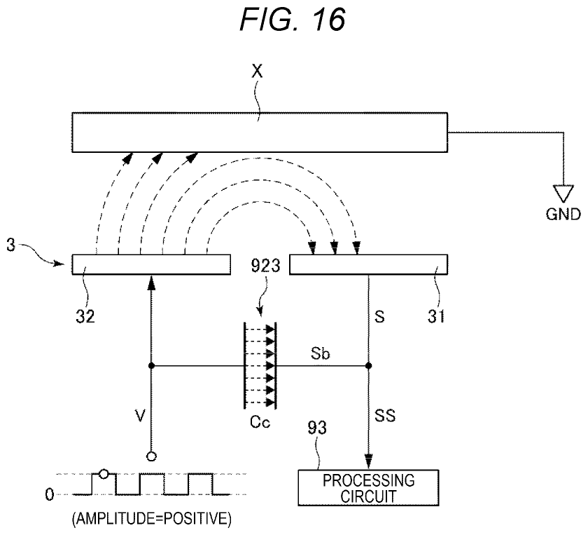

On the contrary, in the model shown in FIG. 16, the proximity sensor 3 interferes with the structure X and the three electric lines of force less than those of the model in FIG. 14 act on the detection electrode 31. At the same time, the capacitance of the variable capacitor 923 is set to capacitance Cc larger than the capacitance Ca by the capacitance control circuit 924, and seven electric lines of force in the same direction as that of the electric lines of force acting on the detection electrode 31 are formed in the variable capacitor 923. That is, in this model, the correction circuit 92 generates the corrected detection signal SS corresponding to the ten electric lines of force by adding the correction signal Sb corresponding to the seven electric lines of force to the detection signal S having the magnitude corresponding to the three electric lines of force. Note that the value of Cc (>Ca) is varied according to the relative position relationship with the structure X, i.e., the number of electric lines of force acting on the detection electrode 31.

As described above, the correction circuit 92 controls the capacitance of the variable capacitor 923 so that the corrected detection signal SS having the magnitude corresponding to the ten electric lines of force may be constantly generated with or without interference. Thereby, the corrected detection signal SS in which fluctuations of the detection signal S due to the posture of the robot arm 21 are cancelled is generated by the correction circuit 92. Then, the processing circuit 93 detects the approach of the object to be detected based on thus generated corrected detection signal SS. According to the configuration, the processing circuit 93 may accurately detect the approach of the object.

As described above, the correction circuit 92 of the embodiment has the variable capacitor 923 as the variable correction capacitance formation unit electrically coupled to the detection electrode 31, and the capacitance control circuit 924 controlling the capacitance of the variable capacitor 923. Thereby, the configuration of the correction circuit 92 is simpler.

As described above, the drive voltage V is applied to the variable capacitor 923. Thereby, the configuration of the correction circuit 92 is simpler.

As described above, in the detection method of detecting the object located around the robot, the capacitance of the variable capacitor 923 as the variable correction capacitance formation unit electrically coupled to the detection electrode 31 is controlled, the detection signal S is corrected, and the corrected detection signal SS is generated. Thereby, the corrected detection signal SS may be generated by the simple method.

As described above, the detection method of detecting the object located around the robot includes acquiring the capacitance information T2 based on the posture of the robot arm 21 and the capacitance of the variable capacitor 923 and controlling the capacitance of the variable capacitor 923 based on the capacitance information T2 and the posture of the robot arm 21. Thereby, the corrected detection signal SS may be generated by the simple method.

According to the second embodiment, the same effects as those of the above described first embodiment may be exerted.

As above, the detection method and robot of the present disclosure are explained based on the illustrated preferred embodiments, however, the present disclosure is not limited to those. The configurations of the respective parts may be replaced by arbitrary configurations having the same functions. Or, another arbitrary configuration may be added.

What is claimed is:

1. A detection method by a robot having a robot arm and a capacitance proximity sensor placed on the robot arm of detecting an object located around the robot, comprising:
applying a drive voltage to a drive electrode of the proximity sensor;
generating a corrected detection signal by correcting a detection signal output from a detection electrode of the proximity sensor based on a posture of the robot arm; and
detecting the object located around the robot based on the corrected detection signal.

2. The detection method according to claim 1, wherein
a correction voltage is applied to a correction capacitance formation unit electrically coupled to the detection electrode, and thereby, the detection signal is corrected and the corrected detection signal is generated.

3. The detection method according to claim 2, wherein
correction voltage information based on the posture of the robot arm and the correction voltage is acquired, and
the correction voltage is controlled based on the correction voltage information and the posture of the robot arm.

4. The detection method according to claim 3, wherein
detection of the posture of the robot arm is based on output of an encoder of the robot arm.

5. The detection method according to claim 1, wherein
a capacitance of a variable correction capacitance formation unit electrically coupled to the detection electrode is controlled, and thereby, the detection signal is corrected and the corrected detection signal is generated.

6. The detection method according to claim 5, wherein
capacitance information based on the posture of the robot arm and the capacitance of the variable correction capacitance formation unit is acquired, and
the capacitance of the variable correction capacitance formation unit is controlled based on the capacitance information and the posture of the robot arm.

7. The detection method according to claim 2, wherein
the drive voltage and the correction voltage are synchronized.

8. A robot comprising:
a robot arm;
a capacitance proximity sensor having a detection electrode and a drive electrode placed on the robot arm and detecting an object located around the robot;
a drive circuit applying a drive voltage to the drive electrode;
a correction circuit generating a corrected detection signal by correcting a detection signal output from the detection electrode based on a posture of the robot arm; and
a processing circuit detecting the object located around the robot based on the corrected detection signal.

9. The robot according to claim 8, wherein
the correction circuit has:
a correction capacitance formation unit electrically coupled to the detection electrode; and
a correction voltage application circuit applying a correction voltage to the correction capacitance formation unit.

10. The robot according to claim 8, wherein
the correction circuit has:
a variable correction capacitance formation unit electrically coupled to the detection electrode, and
a capacitance control circuit controlling capacitance of the variable correction capacitance formation unit.

11. The robot according to claim 10, wherein
the drive voltage is applied to the variable correction capacitance formation unit.
